(19) United States
(12) Patent Application Publication
(10) Pub. No.: US 2002/0124175 A1
(43) Pub. Date: Sep. 5, 2002

(54) Data processing system utilizing discrete operating device

(75) Inventor: Hitoshi Yamakado, Yokohama-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/061,174

(22) Filed: Feb. 4, 2002

(30) Foreign Application Priority Data
Mar. 2, 2001 (JP) 2001-059042

(51) Int. Cl. H04L 9/32; G06F 12/14

(52) U.S. Cl. 713/185

(57) ABSTRACT

ROM 12 of data processing system 1 stores identification data ID. Receiving part 15 receives identification data ID transmitted by discrete operating device 2 in the possession of an authorized user. CPU 10, on the basis of received identification data ID, determines continuously whether the authorized user holding the discrete operating device 2 remains within close range of data processing system 1. While authenticating a user on the basis of the determination result, CPU 10 carries out data processing instigated by an operation of the user holding the discrete operating device 2. Accordingly, it is possible to simply and reliably prevent unauthorized use of a data processing system.

### TECHNICAL FIELD OF THE INVENTION

The present invention relates to a data processing system, and more particularly to a data processing system capable of performing user authentication.

### RELATED ART

In conventional data processing systems such as personal computers or work stations user authentication can be performed by utilizing a user name, password, log-in ID, and the like. Recently, there has been proposed a user authentication method which utilizes not only a user name, password, log-in ID and the like, but also pre-recorded biological information such as a finger print of a user.

While the use of pre-recorded biological identification data of a user represents an advancement in system security, a problem remains that an unauthorized user may still gain access to a system in the event that an authorized user who has supplied biological ID data, such as a fingerprint, fails to log-off from the system.

To reduce the security risks inherent in the conventional art, there is known a method whereby a user of a system repeatedly authorizes him or herself by inputting a user name, password, finger print ID or the like. However, such a method is both time-consuming and inefficient; and, although to a lesser degree, is also subject to the security problems outlined above.

### SUMMARY OF THE INVENTION

The present invention has been made to overcome the stated problems of the conventional art, and has as its object the provision of a data processing system to which access by unauthorized access can be readily, reliably and efficiently prevented.

To achieve this object the present invention comprises: an operating device which transmits user identification data; a detection means for detecting and outputting an operation of an operating device; a storage means for storing identification data; a receiving means for receiving identification data transmitted form the discrete operating device; a determining means for continuously determining whether identification data stored in the storage means is received by the receiving means; an authentication means for authenticating received identification data against stored identification data determined by said determining means as having been received; and a data processing means for carrying out data processing when an authenticating step is positive.

The present invention further provides a control method for a data processor, comprising: a detection step of detecting an operation carried out by an operating device; a receiving step of receiving identification data in a receiving means; a determining step of continuously determining whether identification data stored in the storage means is received; an authenticating step of authenticating against said stored identification data identification data determined in said determining step as having been received; and a data processing step of carrying out, in the event that a result of an authenticating step is positive.

In the present invention, the control method for a data processing system is not limited to being carried out directly within the system itself, but can also be implemented over a telecommunication circuit or distributed in the form of a program stored on any computer-readable media such as a CD-ROM, diskette, optical disc, and so on.

### BRIEF DESCRIPTION OF THE DRAWINGS

FIG. 1 illustrates a data processing system and a pen-form operating device in accordance with an embodiment of the present invention.

FIG. 2 shows the configuration of a display screen of a data processing system.

FIG. 3 is a block diagram showing the electrical configuration of a data processing system and a pen-form operating device of the present invention.

FIG. 4 shows an example of a registration screen displayed by a data processing system of the present invention.

FIG. 5 is a flowchart showing a main routine of a data processing system of the present invention.

FIG. 6 shows an example of an interface screen displayed by a data processing system of the present invention.

FIG. 7 is a flowchart showing an authentication processing of a data processing system of the present invention.

FIG. 8 is a flowchart showing an authentication flag setting processing of a data processing system of the present invention.

FIG. 9 shows an example showing a log-in screen displayed by a data processing system of the present invention.

FIG. 10 is a figure illustrating a modification of one embodiment of the present invention.

FIG. 11 is a figure illustrating another modification of one embodiment of the present invention.

FIG. 12 is a figure illustrating yet another modification of one embodiment of the present invention.

### DETAILED DESCRIPTION OF THE INVENTION

(1) Preferred Embodiment

(1.1) Configuration of Embodiment

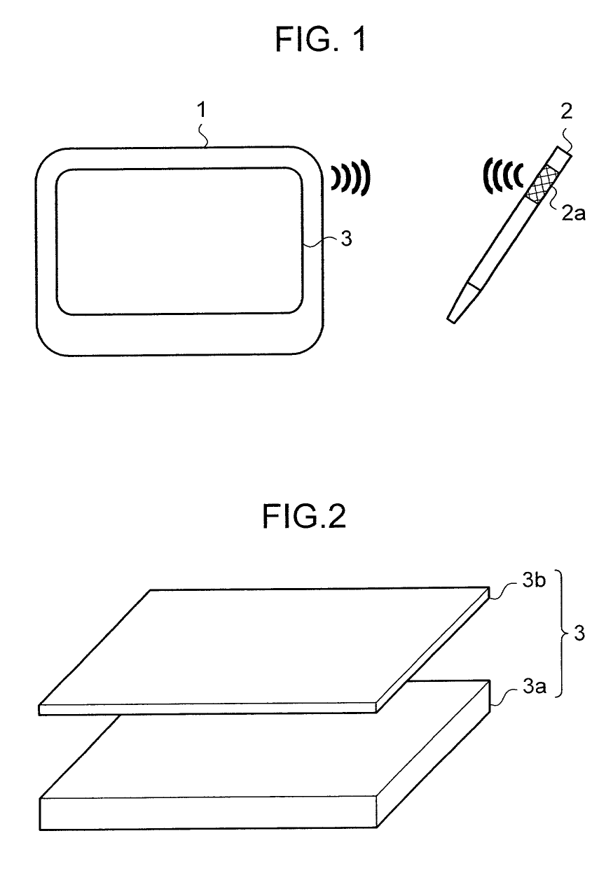

FIG. 1 shows a data processing system 1 and a pen-form operating device 2 used for operating the data processing system 1 in accordance with one embodiment of the present invention. Pen-form operating device 2 is a pointing device that is held in an operator's hand. Data processing system 1 is a discrete device for use at work or at home, and is operated by using pen-form operating device 2.

Data processing system 1 has a slim, generally rectangular body, and has a display 3 covering a general area of its upper surface. Display 3, as shown in FIG. 2, comprises a liquid crystal display panel 3a which has a transparent touch panel 3b as an operation detecting means provided on its upper face. When a user contacts touch panel 3b with operating device 2, a position contacted is detected via touch panel 3b.

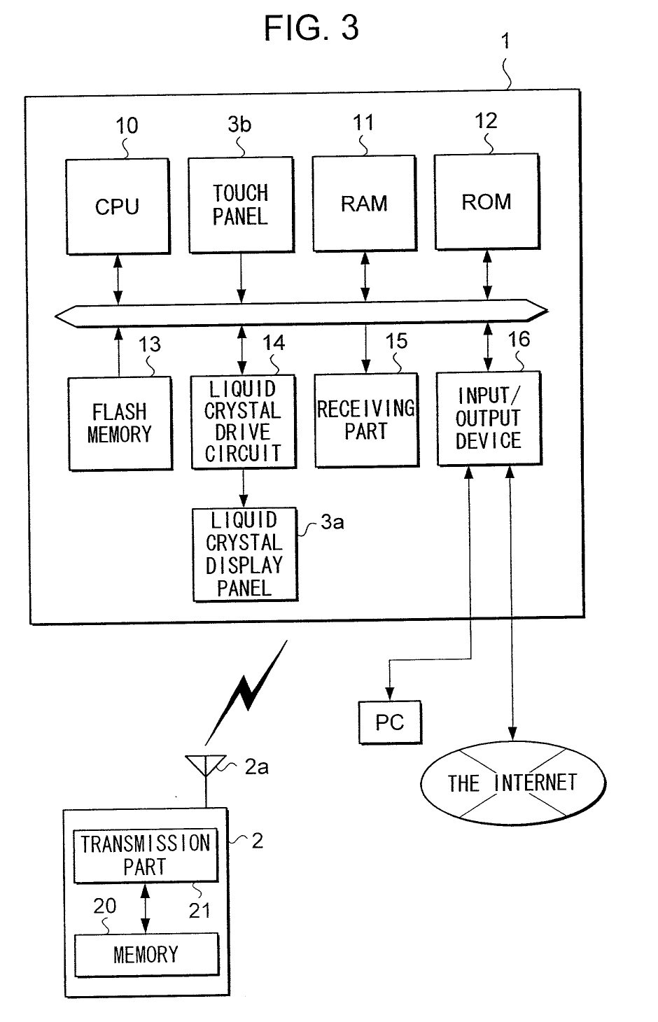

FIG. 3 shows an electrical configuration of an data processing system 1 and a pen-form operating device 2.

Memory 20 of pen-form operating device 2 is used to store user identification data ID. Pen-form operating device 2 is also provided with a battery, to transmit identification data ID stored in memory 20 via an antenna 2a (see FIG. 1). As a battery for pen-form operating device 2, a rechargeable battery may be employed. Further, a battery recharging circuit may be provided in data processing system 1.

Transmission part 21 in pen-form operating device 2 transmits user identification data ID to data processing system 1 by short range wireless communication. Thus, when pen-form operating device 2 is brought within close range of data processing system 1, the latter device is able to receive user identification data ID stored in the former device. Close range refers to a distance of, for example, up to several meters between data processing device 1 and pen-form operating device 2. Usable forms of short range wireless communication may include, for example, electromagnetic or microwave induction, or spread spectrum, such as direct sequence, or frequency hopping modulation.

Receiving part 15 in data processing system 1 receives data via an antenna. Data processing system 1 is also provided with an input/output device 16, which, under control of CPU 10, is used to connect data processing system 1 to the Internet, or to a personal computer (PC) or the like for performing data communication. A ROM 12 as a storage means is provided in data processing system 1 for storing programs and user identification data ID of pen-form operating device 2. A RAM 11, also under control of CPU 10, functions as a buffer memory in which image data and the like is temporarily stored for display on liquid crystal display panel 3a; other data may also be stored in RAM 11. Flash memory 13 is a rewritable nonvolatile memory.

Data for use in a user interface is stored in flash memory 13. In the present embodiment, the user interface is visible to a user in liquid crystal display panel 3a and touch panel 3b. More specifically, CPU 10 displays in liquid crystal panel 3a an interface screen via which a user inputs an instruction by contacting an area on touch panel 3b with any operating device.

In the present embodiment, the interface screen includes images of a plurality of operating icons that represent various processing operations available to a user. Layout data and additional data is stored in flash memory 13 as data to provide such a user interface.

Layout data may include image definitions for representing a size shape, and so on of icon images that are selected to initiate different operations; also included is position data for specifying icon image positions. Additional data is that which specifies an operation to be executed in response to contact with the operating device of a designated area containing an image of an operation icon on touch panel 3b. Additional data corresponding to each operation icon is stored in flash memory 13, and is related to layout data corresponding to each operation icon.

Upon providing power to data processing system 1 by using an ON/OFF switch, CPU 10 is activated as each of a determining means and a data processing means and controls all other data operations of data processing system 1 by reading out and executing a program stored in ROM 12.

As will be apparent from the foregoing description, CPU 10 functions to control attributes of a user interface screen. Illustratively, in the present embodiment, CPU 10 processes (maps) in an image storage area of RAM 11, in accordance with layout data stored in flash memory 13, image data (bit map data) of a group of operation icons. Thus interface screen image data stored in RAM 11 is displayed under operation of liquid crystal drive circuit 14 on liquid crystal display panel 3a.

When touch panel 3b is contacted, CPU 10 determines which operation icon is selected and executes various processing on the basis of the determination result.

More specifically, if any one of operation icons is selected while the identification data ID stored in ROM 12 is received, CPU 10 reads from flash memory 13 the additional data corresponding to the contacted operation icon and executes the processing designated by the additional data. On the other hand, while the identification data ID is not received, even if one of the operation icons is selected, CPU 10 does not execute any processing corresponding to the operation icon.

(1.2) Operation of Embodiment

First, the operation of a data processing system 1 on initial registration processing will be described.

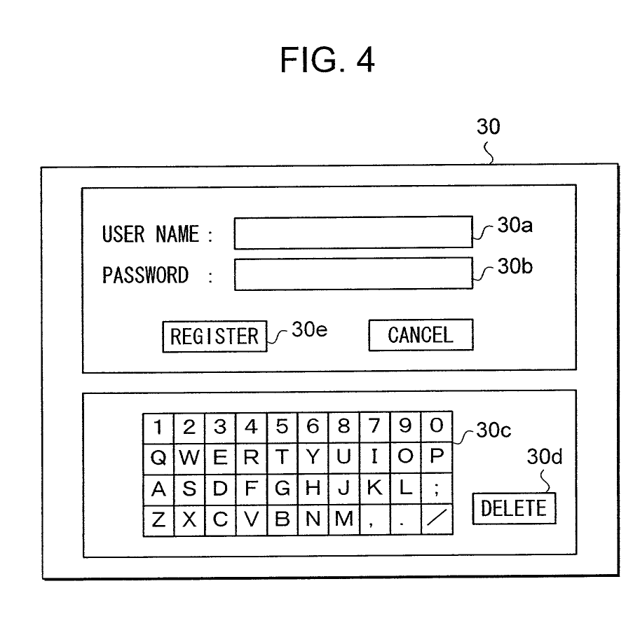

Upon providing power to data processing system 1, CPU 10 executes an initializing processing. In this processing, CPU 10 causes liquid crystal drive circuit 14 to display on display 3 registration screen 30, as shown in FIG. 4. When display 3 is contacted by an operator with using a pen-form operating device 2, CPU 10 registers, in response to a position contacted on touch panel 3b of display 3, a user name and password. More specifically, when determining that the position contacted is in a user name input field 30a or in a password input field 30b, CPU 10 makes cursor blink by liquid crystal drive circuit 14 on the corresponding position on either input field 30a or 30b. Also when determining that the position contacted corresponds to a letter or the like in letter palette 30c, CPU 10 causes a letter or the like to be displayed in either input field 30a or 30b where the cursor is active. On the other hand, if it is determined that a position contacted corresponds to delete icon 30d, CPU 10 causes a letter or the like to be deleted, a letter or the like staying where the cursor is blinking in input field 30a or 30b. Also when determining that a position contacted with the operating device corresponds to registration icon 30e, CPU 10 stores in flash memory 13 the user name and the password input in each input field 30a and 30b. When the storing processing is complete, CPU 10 completes registration processing of user name and password. The user name and password stored in flash memory 13 are nonvolatile.

Subsequently, when power is again provided to data processing system 1, CPU 10 executes a main routine stored in ROM 12 since the initialization processing has already been completed.

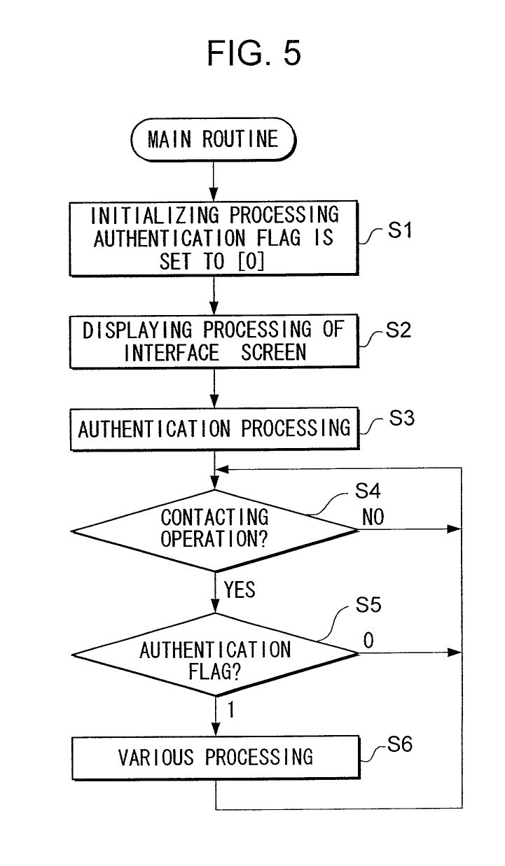

FIG. 5 is a flowchart showing a main routine. It is to be noted that CPU 10 is supplied with an interrupt pulse at evenly spaced time intervals. Each time an interrupt pulse is supplied, CPU 10 intermits a currently active processing and handles, as an interrupt, a routine of setting processing of an authentication flag memorized in ROM 12.

To further exemplify such a main routine, a routine of the interrupt processing handled by CPU 10 will be explained.

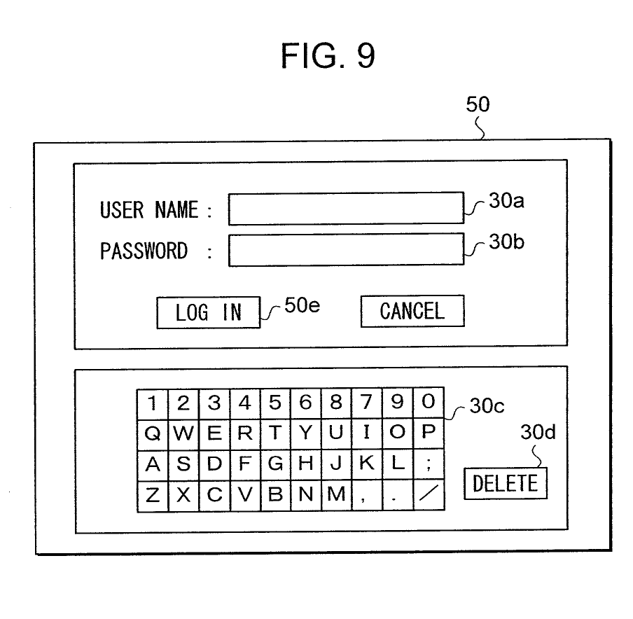

FIG. 9 shows a routine of setting processing of an authentication flag.

When initiating execution of an interrupt routine upon being supplied with an interrupt pulse, CPU 10 determines whether identification data ID (hereinafter received identification data ID is referred to as “identification data IDa”) is received by receiving part 15 (step S16). If a determination result of step S16 is “YES”, CPU 10 determines whether the received identification data IDa is same with the identification data ID stored in ROM 12 (step S17). If a determination result of step S17 is “YES”, CPU 10 sets in a predetermined area of RAM 11 “1” as an authentication flag F (step S19) and completes the routine.

On the other hand, if a determination result of step S16 is “NO” or a determination result of step S17 is “NO”, CPU 10 sets in a predetermined area of RAM 11 “0” as an authentication flag F (step S18) and completes the routine.

Each time an interrupt pulse is supplied, CPU 10 executes the above processing. Accordingly, while receiving identification data IDa same with identification data ID stored in ROM 12, CPU 10 maintains an authentication flag F as “1”, by repeating a processing of step S16, S17 and S19, whereas CPU 10 maintains an authentication flag F as “0” by repeating a processing of step S16, (S17) and S18, while the identification data IDa is not received.

Next, a main routine of a data processing system 1 will be explained with referring to a flowchart as shown in FIG. 5.

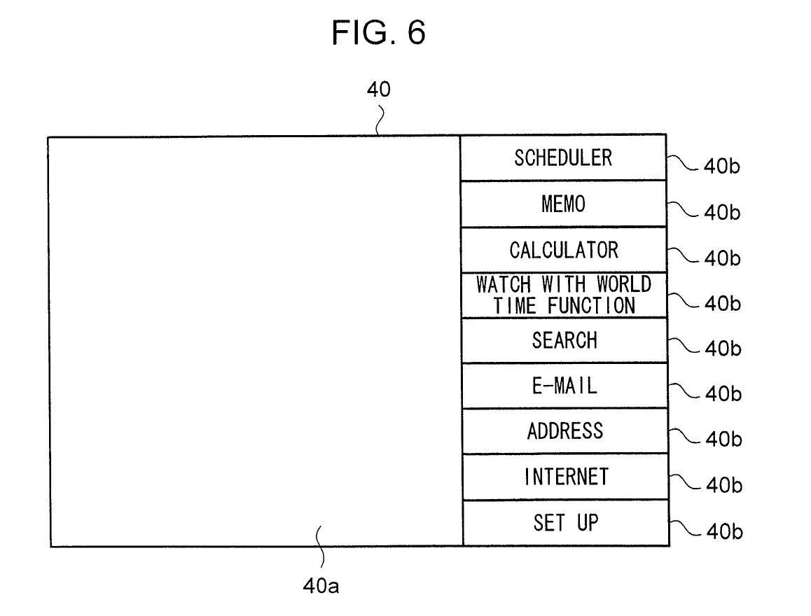

As a first step of the main routine, CPU 10 performs initialization (step SI). In the processing of initialization, CPU 10 sets an authentication flag F to “0” in a predetermined area of RAM 11. After the initialization is completed, CPU 10 makes liquid crystal drive circuit 14 display interface screen 40 in display 3 (step S2). FIG. 6 shows an example of interface screen 40. In this displaying processing, CPU 10 processes in a image storage area of RAM 11 mapping of image data (bit map data) of groups of operation icons, in accordance with layout data stored in flash memory 13. As a consequence, interface screen 40 as shown in FIG. 6, is displayed on liquid crystal panel 3a by liquid crystal drive circuit 14. On this screen are arranged a plurality of operation icons 40bs, each corresponding to a different processing operation.

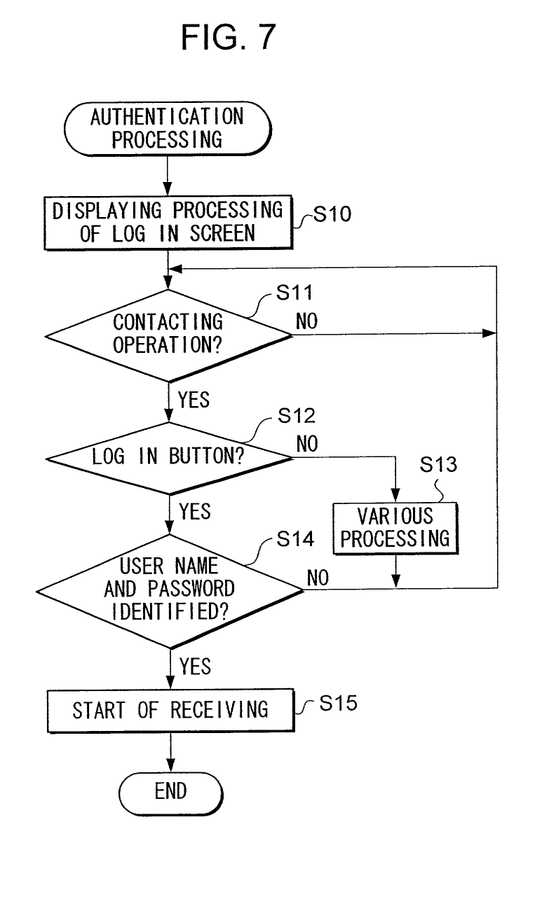

When step S2 is complete, CPU 10 starts an authentication processing as shown in FIG. 7 (step S3).

The authentication processing will be explained with referring to a flowchart of an authentication processing as shown in FIG. 7.

First, CPU 10 makes liquid crystal drive circuit 14 display log in screen 50 on display 3 (step S10). FIG. 9 shows an example of log in screen 50. Log in screen 50 is generally similar to a registration screen 30 (see FIG. 4) except in terms of having a “log in” icon 50e instead of “registration” icon 30e, and like parts are therefore denoted by like reference numerals. Next, when the position contacted is informed by touch panel 3b (step S11: YES), CPU 10 determines whether the position corresponds to log in icon 50e (step S12). When the position contacted is anywhere but on “log in” icon 50e, CPU 10 performs processing in the same way as it does in the case of registration screen 30 (step S13). An operator inputs his or her user name and password in input field 30a and 30b in the same way as he or she does in the case of registration screen 30.

On the other hand, if it is determined that a position contacted corresponds to log-in icon 50e (step S12: YES), CPU 10 determines whether the input user name and password are the same as those stored in flash memory 13 (step S14). If a result in this step is “NO”, CPU 10 returns to step S11. On the other hand, if the result of step S14 is “YES”, CPU 10 instructs receiving part 15 to start receiving (step S15).

When the authentication processing as shown in FIG. 7, that is, the step S3 in FIG. 5 is complete, CPU 10 determines whether any contacting operation on touch panel 3b is performed (step S4). When its determination result is “NO”, CPU 10 repeats the same determination. When touch panel 3b is contacted, a determination result of step S4 becomes “YES”, and the processing by CPU 10 goes to step S5. In step S5, CPU 10 determines whether an authentication flag F stored in RAM 11 is “1” or “0”.

As has already been explained, the routine of setting processing of an authentication flag is executed repeatedly as an interrupt routine by CPU 10. Determination in step S5 of whether authentication flag F is “1” or “0” depends on an execution result of authentication flag setting processing routine executed immediately prior to the determination.

On the determination in step S5, if authentication flag F is “0”, CPU 10 returns processing to step S4.

On the other hand, if the authentication flag F is “1”, CPU 10 determines where on interface screen 40, the contacted position sensed by touch panel 3b corresponds, and executes a processing operation in accordance with the determination result (step S6). More specifically, if “scheduler” icon 40b (see FIG. 6) is selected, CPU 10 inverts image data of “scheduler” icon 40b in an image storage area of RAM 11. As a consequence, “scheduler” icon 40b is displayed in inverse video on interface screen 40 displayed on liquid crystal panel 3 a. CPU 10 also reads from flash memory 13 additional data corresponding to “scheduler” icon 40b. Additional data includes information designating an application program for “scheduler”. CPU 10 executes the application program designated by additional data. In the execution process, CPU 10 reads form flash memory 13 schedule information of a user and produces a schedule image and writes the image into an area corresponding to work area 40a, as shown in FIG. 6, within the image storage area of RAM 11. As a result, a schedule image is displayed in work area 40a of liquid crystal display panel 3a. Some of the application programs executed by CPU 10 accept input of letters and drawings by a user. In such a case, an operation is carried out as follows. When a user selects with pen-form operating device 2 a position in work area 40a and then moves the operating device to continuously select further different position, data corresponding to each selected position is transmitted from touch panel 3b to CPU 10. Each time data for selected positions is generated, CPU 10 writes within the image storage area of RAM 11, dot image data which represents positions selected in an area corresponding to work area 40a as shown in FIG. 6. As a result, a shifting trail representation of positions selected by a pen-form operating device 2 is displayed in work area 40a of liquid crystal panel 3a. On the basis of selected position data generated via touch panel 3b, CPU 10 is able to determine information input by a user, such as letters, and executes data processing. A user may, in addition to letters, also input figures; and an application program executed by CPU 10 determines whether input information input is in the form of letters or figures.

As has been explained, when processing in step S6 has been completed, CPU 10 returns to step S4, and repeats the processing of step S4, S5 and S6, until power is turned off.

Thus, in response to an operation using pen-form operating device 2 to select an area of touch panel 3b, CPU 10 refers to an authentication flag F and determines whether to perform the corresponding data processing operation, depending on whether the authentication flag F is “1” or “0”.

As explained up to this point, in the present embodiment, after the reception of identification data by data processing system 1 starts (step S15), CPU 10 continuously determines whether the identification data IDa same with identification data ID stored in ROM 12 is received in receiving part 15. Also in the present embodiment, continuous determination is made upon use of data processing system 1, whether a user is authorized. Consequently, data processing system 1 will perform processing operations corresponding to an operation input by a user via touch panel 3b, only while a pen-form operating device 2 of an authorized person is within close range of data processing device 1 (that is, only while the authentication flag F is “1”) Accordingly, data processing system 1 can immediately detect a situation where an authorized person is remote, and thereby prevent any unauthorized access or input to the system until such time as an authorized user returns to a proximate position.

Also, since data processing system 1 can be used when pen-form operating device 2, which is transmitting identification data IDa the same as identification data ID stored in ROM 12, is within close range of data processor 1, it also can be operated by another operating device so long as an authorized person carrying pen-form operating device 2 is within close range of data processing system 1. Accordingly, for example, an authorized person can hand data processing system 1 to an unauthorized person to enable him or her to input, for example, a telephone number using his or her own pen-form operating device, while at the same time preventing unauthorized access to the system.

Thus the present invention is able to simply and reliably prevent any unauthorized use, by determining continuously whether an authorized user remains within close range of the data processing device; which determination is made on the basis of identification data transmitted from a discrete operating device used by the authorized user.

(2) Modification of Embodiment

As will be readily apparent, the present invention is not limited to the embodiment described above, and various modifications can be implemented without departing from its scope. By way of illustration, the following modification is described.

(2.1)

In the above embodiment, by employing a timer, for example, during periodical interrupt of reception determination and identification determination processing, identification determination can also be performed. A timer used for this purpose could be set to activate such an operation once every several seconds.

(2.2)

In the above embodiment, CPU 10 determines authentication at established intervals. Obviously, if a receiving operation is performed only at a time when a determining operation is performed, power consumption of the system can be reduced. In other words, the system can be configured such that receiving part 15 performs intermittent receiving operations which are synchronized with determinations made by CPU 10.

(2.3)

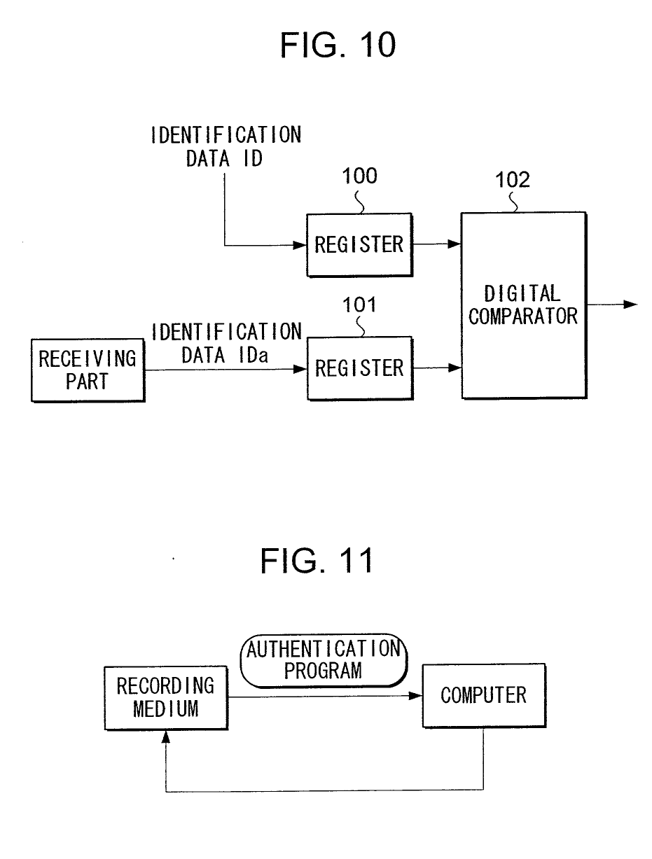

In the above embodiment, determination of identification data is performed by CPU 10 processing based on a program. On the other hand, as shown in FIG. 10, by providing a register 100 storing identification data ID, a register 101 to which received identification data IDa is transferred, and a digital comparator 102, digital comaprator 102 may be made determine whether data stored in register 100 maches data transferred to rgister 101. In other words, the present invention can be implemented by means of both software and hardware.

(2.4)

In the above embodiment, authentication is performed on the basis of an input user name and password, and on received identification data ID. However authentication can also be performed only on the basis of identification data ID.

(2.5)

In the above embodiment, pen-form operating device 2 transmits identification data ID periodically, but identification data ID can also be transmitted only at a time when pen-form operating device 2 receives a transmission request for identification data ID from data processing device 1. This function can be attained by providing an appropriate receiving part in pen-form operating device 2, as along with a transmission part in data processor 1. As a result, overall power consumption of pen-form operating device 2 can be reduced, and its operating time extended.

(2.6)

In the above embodiment, the present invention is applied to data processing device 1 which is operated by pen-form operating device 2. However, the present invention can be applied to any data processor operable by any discrete operating device, such as a tablet or a mouse. In the present invention in the interest of security, a user preferably carries a discrete operating device which is cordless. As will be apparent, the data processing device of the present invention may include any type of computer, including Personal Computers (PCs), Personal Digital Assistants (PDAs) and so on.

(2.7)

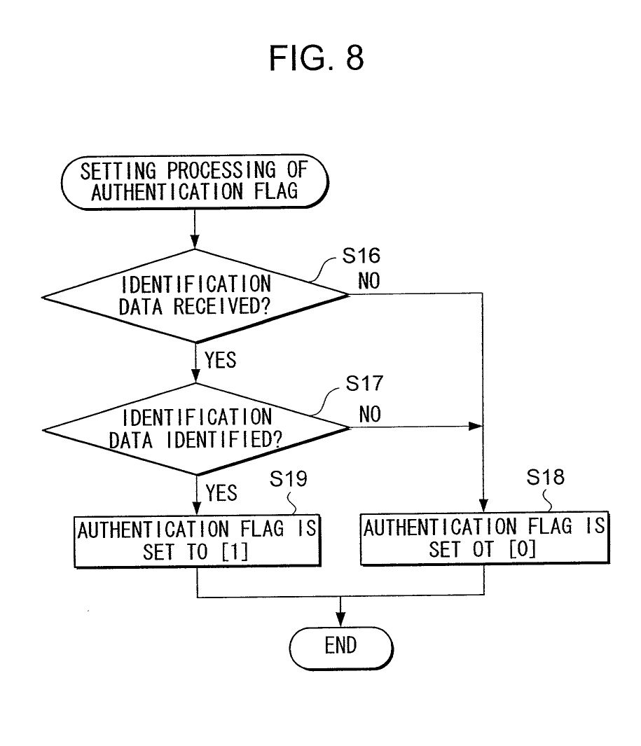

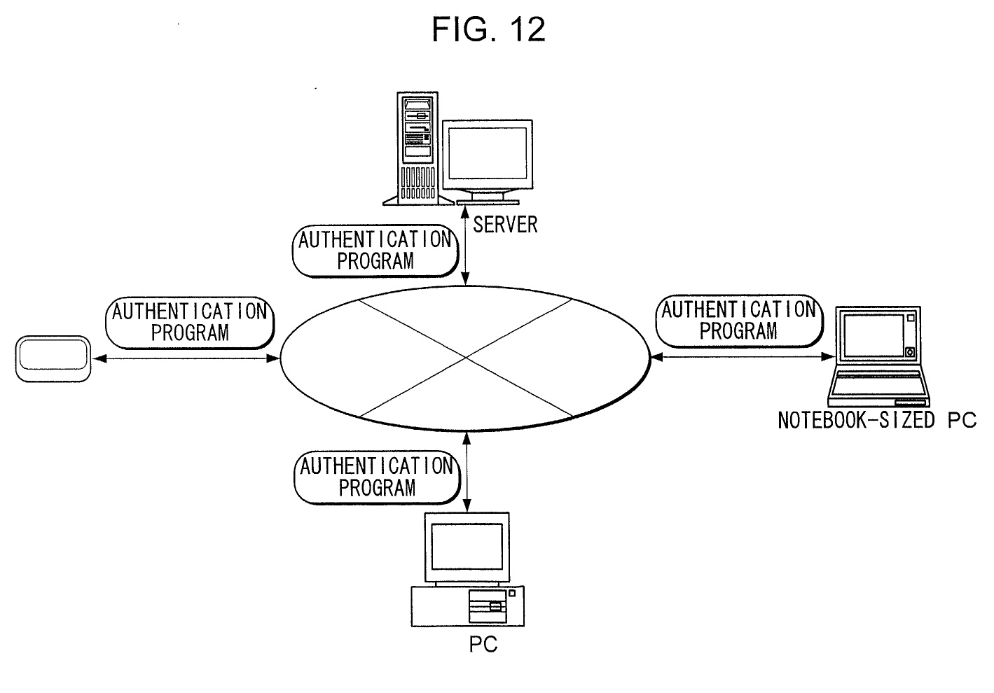

In the above embodiment, programs for executing an authentication processing as illustrated in FIG. 7 and setting processing of authentication flag as illustrated in FIG. 8 are previously stored in data processing system 1. However, these programs may also be stored, as shown in FIG. 11, in any computer-readable recording medium, such as a magnetic recording medium, optical recording medium or semiconductor storage medium so as to be read and executed by a computer. Also, as shown in FIG. 12, these authentication programs can be stored in a server to be transmitted to a terminal such as a PC when a transmission request is made via a network.

What is claimed is:

1. A data processor, comprising:
a discrete operating device for transmitting identification data;
an operation detection means for detecting and outputting an operation of an operating device;
a storage means for storing identification data;
a receiving means for receiving identification data;
a determining means for continuously determining whether identification data stored in said storage means is received by said receiving means;
an authentication means for authenticating against said stored identification data identification data determined by said determining means as having been received; and
a data processing means for carrying out data processing on the basis of a detection result of said operation detection in the case that a positive result is obtained by said authentication means.

2. A data processor as claimed in claim 1, wherein:
said storage means is used to pre-store user data as well as said identification data;
said authentication means authenticates against said stored identification data identification data determined by said determining means as having been received after input of data the same as said user data is detected by said operation detection means;

3. A control method for a data processor, comprising:
a receiving step of receiving identification data in a receiving means;
a determining step of determining continuously whether identification data stored in storage means is received in said receiving means;
an authenticating step of authenticating against said stored identification data identification data determined in said determining step as having been received;
a detection step of detecting an operation of an operating device; and
a data processing step of carrying out data processing on the basis of a detection result of said detection step in the case that a result of said authenticating step is positive.

4. A control method for a data processor as claimed in claim 3, further comprising a step of pre-storing user data in said storage means, said authenticating step comprising;
authenticating against said stored identification data identification data determined in said determining step as having been received after input of data the same as said user data is detected by an operation detection means.

5. A control program product for a computer for executing the processes of:
receiving identification data in a receiving means;
determining continuously whether identification data stored in a storage means is received;
authenticating against said stored identification data identification data determined in said determining step as having been received;
detecting an operation of an operating device; and
carrying out data processing on the basis of a detection result of said operation detecting step in the case that a result of said authenticating process is positive.

6. A control program product as claimed in claim 5, for a computer further executing a process of pre-storing user data in said storage means, said authenticating includes;
authenticating against said stored identification data identification data determined in said determining process as having been received after input of data the same as said user data is detected by an operation detection means.

7. A computer-readable recording medium that has recorded a control program for causing a computer execute the processes of:
receiving identification data in a receiving means;
determining continuously whether identification data stored in a storage means is received;
authenticating against said stored identification data identification data determined in said determining step as having been received;
detecting an operation of an operating device; and
carrying out a data processing on the basis of a detection result of said operation detecting process in the case that a result of said authenticating process is positive.

8. A computer-readable recording medium as claimed in claim 7, wherein said control program for a computer further executes a process of pre-storing user data in said storage means, said authenticating process comprising;
authenticating against said stored identification data identification data determined in said determining process as having been received after input of data the same as said user data is detected by an operation detection means.
